(19) United States
(12) Patent Application Publication
(10) Pub. No.: US 2018/0355744 A1
(43) Pub. Date: Dec. 13, 2018

(54) ABRADABLE STRUCTURE FOR A TURBOMACHINE, TURBOMACHINE HAVING AN ABRADABLE STRUCTURE, AND METHOD FOR MANUFACTURING AN ABRADABLE STRUCTURE

(71) Applicant: MTU Aero Engines AG, Muenchen (DE)

(72) Inventors: Andreas JAKIMOV, Fahrenzhausen (DE); Steffen SCHLOTHAUER, Erdweg (DE); Beatrice LORENZ, Muenchen (DE)

(21) Appl. No.: 15/991,616

(22) Filed: May 29, 2018

(30) Foreign Application Priority Data
Jun. 8, 2017 (DE) 102017209658.6

(51) Int. Cl. F01D 11/12

(52) U.S. Cl. CPC F01D 11/122; F05D 2240/55; B33Y 10/00; F05D 2250/132; F05D 2250/131; F05D 2230/31

(57) ABSTRACT

An abradable structure (10) for a turbomachine (40) that is designed to be at least partially deformed and/or at least partially abraded by at least one abrading element (44, 47) of the turbomachine (40) during operation thereof; the at least one abradable structure (10) being formed at least regionally of structural elements (12, 14, 16, 18) that have a respective polygonal cross section (20, 22) that is oriented in a rub direction (X_A) of the abradable structure (10). The structural elements (12, 14, 16, 18) have a greater extent (Xₕ, Xᵣ) in the rub direction (X_A) than in a direction of the abradable structure (10) that is orthogonal to the rub direction (X_A). Other aspects of the present invention relate to a turbomachine (40) having an abradable structure (10), as well as to a method for manufacturing an abradable structure (10).

This claims the benefit of German Patent Application DE 102017209658.6, filed Jun. 8, 2017 and hereby incorporated by reference herein.

The present invention relates to an abradable structure for a turbomachine that is designed to be at least partially deformed and/or at least partially abraded by at least one abrading element of the turbomachine during operation thereof, the at least one abradable structure being formed at least regionally of structural elements having a respective polygonal cross section that is oriented in a rub direction of the abradable structure. Other aspects of the present invention relate to a turbomachine having an abradable structure, as well as to a method for manufacturing an abradable structure.

### BACKGROUND

Abradable structures of this kind are used, for example, as stator-side abradable coatings on rotor blades of a high-pressure compressor. Abradable structures are frequently used in turbomachines when it is unavoidable, desired or, in certain operating states, likely that blade tips or sealing fins of the turbomachine and of a metallic surface make contact in the area of a casing of the turbomachine or of a shaft, for example. The abradable structure makes it possible to enhance the gap characteristics of the turbomachine, a contact between the rotor and stator of the turbomachine possibly being required to realize especially narrow gaps to increase the efficiency of the turbomachine. If the rotor of the turbomachine expands to a greater degree during operation than the casing thereof, for example, this can lead to a contacting of blade tips of the rotor and of the abradable structure configured on the casing, for example. Accordingly, this contacting can cause the radial gap between the blade tip and the abradable structure to then drop to value “0.” To protect the rotor from damage, for example, the abradable structure has a low strength in comparison thereto, allowing the blade tips to “rub into” the abradable structure without significant resistance during operation of the turbomachine.

In tribological systems, where there can be a contact between a stator vane and the rotor of the turbomachine, one or a plurality of abradable structures can be used to make possible a rubbing contact between the stator vane tip and the rotor without damaging the rotor. The abradable structures can then be accommodated on the rotor, a rubbing contact of the stator vane tip against the abradable structure being possible during operation of the turbomachine.

The most frequent application cases of turbomachines configured as turbines include a combination of abradable structures, in the form of a honeycomb seal, having rotor blades, whose tips are provided with a shroud and sealing ribs (which may also be referred to as “fins”). The shroud thereby enhances the sealing action by minimizing the gap at the blade tips; the fins being able to thereby rub into the honeycomb seal. The sealing fins are also frequently configured directly on the rotor disks. To that end, the rotor disks include arms or inner bands that essentially extend in the direction of flow or counter thereto, upon which the sealing fins are configured upstream and/or downstream and cooperate with corresponding stator-side abradable structures.

### SUMMARY OF THE INVENTION

It is an object of the present invention to provide an abradable structure for a turbomachine that has favorable rubbing contact properties and favorable sealing properties. Other aspects of the present invention reside in providing a turbomachine having an abradable structure of this kind, as well as a method for manufacturing such an abradable structure.

The present invention provides an abradable structure, a turbomachine, and a method for manufacturing an abradable structure. Advantageous embodiments including useful refinements of the present invention are discussed below; advantageous embodiments of the abradable structure being considered as advantageous embodiments of the turbomachine and of the method.

A first aspect of the present invention relates to an abradable structure for a turbomachine that is designed to be at least partially deformed and/or at least partially abraded by at least one abrading element of the turbomachine during operation thereof, the at least one abradable structure being formed at least regionally of structural elements having a respective polygonal cross section that is oriented in a rub direction of the abradable structure. The structural elements may be configured as individual hollow structures and feature a structural element opening that is bounded by the polygonal cross section. The structural elements may also have different polygonal cross sections and, accordingly, different polygonal contours. The rub direction may also be understood to be a direction of a blade movement of the at least one abrading element of the turbomachine relative to the abradable structure. Accordingly, the rub direction may be understood, for example, to be a direction of a movement of a blade tip, for example, of a rotor of the turbomachine, or of a sealing fin relative to the abradable structure during operation of the turbomachine. If the abradable structure is used in the turbomachine, the rub direction may be oriented in the circumferential direction of a casing of the turbomachine or in the circumferential direction of a rotor of the turbomachine. Accordingly, the abradable structure may regionally feature a curvature in the circumferential direction, so that a gap may form between the respective blade tips and the abradable structure during operation of the turbomachine. If the size of the gap decreases, for example, due to operationally induced changes in length (for example, because of thermal expansion of the blade elements during operation of the turbomachine), then contact may occur between the blade tips and a structural surface of the abradable structure. This may cause the abradable structure to become at least partially deformed and additionally or alternatively at least partially abraded in the region of the structural surface.

The present invention provides that the structural elements have a greater extent in the rub direction than in a direction of the abradable structure that is orthogonal thereto. Thus, in comparison to the direction of the abradable structure that is orthogonal to the rub direction, the structural elements may be elongated in the rub direction. In comparison to the non-elongated polygonal cross section, a cross-sectional area of the polygonal cross section may be reduced by the elongation, particularly if the extent in the orthogonal direction is able to be decreased by the elongation in comparison to the non-elongated polygonal cross section. This cross-sectional area also corresponds to a leakage area, the sealing properties of the individual structural elements and thus of the entire abradable structure being all the better the smaller the leakage area is. In other words, the respective gap losses or flow losses decrease during operation of the turbomachine in response to the leakage area, thus the cross-sectional area of the polygonal cross sections, diminishing.

The greater extent of the structural elements in the rub direction than in the direction of the abradable structure that is orthogonal thereto also results in enhanced rubbing properties. The reason for this is that, in response to increasing elongation in the rub direction, the wall surface areas of a respective structural element become smaller in proportion to the sum of the wall surface areas and the inner surface bounded by the polygonal cross section. Thus, in other words, with increasing elongation in the rub direction, the proportion of wall surface areas in the polygonal cross section decreases in comparison to the inner surface area that is bounded by the polygonal cross section. The inner surface may correspond to an opening area of the structural element opening. This makes it altogether possible for the elongation of the structural elements to decrease the size of a rub surface where the abrading element is able to contact the abradable structure during a rubbing-in process, so that, during rubbing contact or rubbing in, the respective structural elements provide a small resistance to the abrading element, thereby enhancing the rubbing properties.

The polygonal cross section may preferably be irregular. A polygonal cross section is irregular when it has dissimilar, thus different sized interior angles. Such an irregular polygonal cross section makes it very readily possible to realize the greater extent in the rub direction than in the direction that is orthogonal thereto. The irregular polygonal cross section may preferably then be elongated in the rub direction. In this case, the irregular polygonal cross section may be symmetrically disposed relative to a plane of symmetry that runs through the rub direction or symmetrically disposed relative to a plane that is parallel thereto. This makes possible an especially uniform loading of the structural element in the case of a possible rubbing in (rubbing-in process) or rubbing against (rubbing-against process). The rub direction may extend in a circular-segment and thus curved shape in correspondence with a rotary motion of the abrading element during operation of the turbomachine, whereby the plane of symmetry is then uniquely defined by the path thereof along the rub direction.

In an advantageous embodiment of the present invention, the structural elements feature structural element walls that converge in the rub direction at least at a respective structural element end and form an acute interior angle. This is advantageous since the acute interior angle allows force to be introduced very efficiently in the rub direction into the respective structural elements, making it possible to effectively prevent any folding of the structural element walls in response to forces acting on the structural elements during the rubbing contact because of the convergence of the structural element walls in the acute interior angle. Such a folding may lead to increased leakage and thus to deteriorating sealing properties during operation of the turbomachine.

In another advantageous embodiment of the present invention, the acute interior angle corresponds to an angle of between 10° and 80°, preferably of between 30° and 60°, and especially of between 38° and 55°. An angle of between 10° and 80° is understood to be within the scope of the inventive angle of 10.0°, 10.5°, 11.0°, 11.5°, 12.0°, 12.5°, 13.0°, 13.5°, 14.0°, 14.5°, 15.0°, 15.5°, 16.0°, 16.5°, 17.0°, 17.5°, 18.0°, 18.5°, 19.0°, 19.5°, 20.0°, 20.5°, 21.0°, 21.5°, 22.0°, 22.5°, 23.0°, 23.5°, 24.0°, 24.5°, 25.0°, 25.5°, 26.0°, 26.5°, 27.0°, 27.5°, 28.0°, 28.5°, 29.0°, 29.5°, 30.0°, 30.5°, 31.0°, 31.5°, 32.0°, 32.5°, 33.0°, 33.5°, 34.0°, 34.5°, 35.0°, 35.5°, 36.0°, 36.5°, 37.0°, 37.5°, 38.0°, 38.5°, 39.0°, 39.5°, 40.0°, 40.5°, 41.0°, 41.5°, 42.0°, 42.5°, 43.0°, 43.5°, 44.0°, 44.5°, 45.0°, 45.5°, 46.0°, 46.5°, 47.0°, 47.5°, 48.0°, 48.5°, 49.0°, 49.5°, 50.0°, 50.5°, 51.0°, 51.5°, 52.0°, 52.5°, 53.0°, 53.5°, 54.0°, 54.5°, 55.0°, 55.5°, 56.0°, 56.5°, 57.0°, 57.5°, 58.0°, 58.5°, 59.0°, 59.5°, 60.0°, 60.5°, 61.0°, 61.5°, 62.0°, 62.5°, 63.0°, 63.5°, 64.0°, 64.5°, 65.0°, 65.5°, 66.0°, 66.5°, 67.0°, 67.5°, 68.0°, 68.5°, 69.0°, 69.5°, 70.0°, 70.5°, 71.0°, 71.5°, 72.0°, 72.5°, 73.0°, 73.5°, 74.0°, 74.5°, 75.0°, 75.5°, 76.0°, 76.5°, 77.0°, 77.5°, 78.0°, 78.5°, 79.0°, 79.5°, 80.0°. These angles permit an especially free selection of the particular polygonal cross section of the structural elements. Especially beneficial rubbing and sealing properties are attainable at an angle of between 38° and 55°, for example. Thus, at an interior angle of 40° or 53°, excellent values may be achieved for the rubbing and sealing properties.

Another advantageous embodiment of the present invention provides that the structural elements feature at least two spaced apart element walls that are oriented along the rub direction. This is advantageous since it is very readily possible to elongate the structural elements by lengthening the respective element walls; at the same time, the inner surface of the structural elements bounded by the polygonal cross section increasing to an appreciably greater extent than the wall surface area of the element walls enlarges, making it possible to very beneficially influence the rubbing properties.

Another advantageous embodiment of the present invention provides that at least one structural element of the abradable structure feature a hexagonal or diamond cross section. In other words, the respective polygonal cross section may be configured as a hexagonal or as a diamond cross section. Such a hexagonal or diamond cross section makes possible an especially regular array of the structural elements of the abradable structure. This makes it possible to achieve an especially uniform sealing action over the entire abradable structure. When at least some of the structural elements have the diamond cross section, significant degrees of freedom are achieved in an array of the individual structural elements relative to each other and/or next to each other. When at least some of the structural elements have the hexagonal cross section, this makes it possible for the rubbing forces that act during a rubbing contact process to be deflected very smoothly to respective, mutually adjoining element walls or wall portions of the particular structural element.

In another advantageous embodiment of the present invention, mutually adjoining structural elements have at least one shared wall. At least regionally, the shared wall may thereby bound the respective polygonal cross section of the mutually adjoining structural elements. The shared wall may also correspond to a wall portion of a structural element wall of the respective, mutually adjoining structural elements. Forming the shared wall is advantageous since, in comparison to related art structures where the respective honeycomb walls are configured separately from each other, weight may be altogether hereby economized.

In another advantageous embodiment of the present invention, the mutually adjoining structural elements mutually overlap at the shared wall. This is advantageous since the overlapping makes possible an especially compact array of the structural elements that is stiff in response to mechanical loads. In the case of such an overlapping, the shared wall may correspond to a wall portion of a structural element wall or of an element wall of the respective, mutually adjoining structural elements.

Another advantageous embodiment of the present invention provides that the abradable structure have at least one carrier element that is adapted for attaching the abradable structure to the turbomachine. This is advantageous since the carrier element makes possible an especially secure attachment of the abradable structure to the turbomachine. The carrier element may be configured as a hollow-cylindrical shell part, for example, for mounting the structural elements thereon and joining them thereto.

In another advantageous embodiment, the abradable structure is formed in one piece. This is especially beneficial, for example, since adjacent, thus mutually adjoining structural elements may be manufactured together and thereby joined. This eliminates the need for a complex and costly joining of the individual structural elements, for example, by brazing, as is known from the related art.

A second aspect of the present invention relates to a turbomachine having an abradable structure in accordance with the first inventive aspect. The features derived therefrom and the advantages thereof are to be inferred from the description of the first inventive aspect. Advantageous embodiments of the first inventive aspect are thereby to be considered as advantageous embodiments of the second inventive aspect and vice versa.

A third aspect of the present invention relates to a method for manufacturing an abradable structure. The present invention provides that the abradable structure be produced by an additive manufacturing process, in particular by selective laser melting. This is advantageous since such additive manufacturing processes make it possible for the abradable structure to be manufactured as a single piece, thus for the production time to be reduced in comparison to related art multipiece structures. Furthermore, a manufacturing using selective laser melting permits substantial design freedom during manufacture of the individual structural elements, for example. In particular, mutually adjoining structural elements having shared walls may be thereby manufactured.

### BRIEF DESCRIPTION OF THE DRAWINGS

Further features of the present invention will become apparent from the claims and the exemplary embodiments. The features and feature combinations mentioned above in the description, as well as the features and feature combinations mentioned below in the exemplary embodiments and/or described in isolation may be used not only in the particular stated combination, but also in other combinations or alone, without departing from the scope of the present invention. Thus, variants of the present invention are also considered to have been included and described herein that are not explicitly described and explained in the exemplary embodiments, but derive from and may be produced by separate combinations of features from the stated variants. Embodiments and combinations of features are also considered to be disclosed herein that, therefore, do not have all of the features of an originally formulated independent claim. In the drawing,

FIG. 1a shows a cross-sectional view of a portion of a turbomachine, an abradable structure being accommodated on a casing of the turbomachine to enable a tip of a blade element acting as an abrading element to rub into the abradable structure;

FIG. 1b shows a cross-sectional view of a portion of the turbomachine, the abradable structure being accommodated on a rotor to enable the blade element acting as an abrading element to rub against the abradable structure;

FIG. 1c shows a cross-sectional view of a portion of the turbomachine, the abradable structure being accommodated on a stator to enable sealing fins acting as abrading elements to rub against the abradable structure;

FIG. 2a is a plan view of two structural elements of the abradable structure, the structural elements having a hexagonal cross section;

FIG. 2b is a plan view of a portion of the abradable structure having a plurality of adjacently disposed structural elements that have the hexagonal cross section;

FIG. 3a is a plan view of another structural element of the abradable structure, the further structural element having a diamond cross section; and

FIG. 3b is a plan view of an array of a plurality of structural elements that feature the diamond cross section.

### DETAILED DESCRIPTION

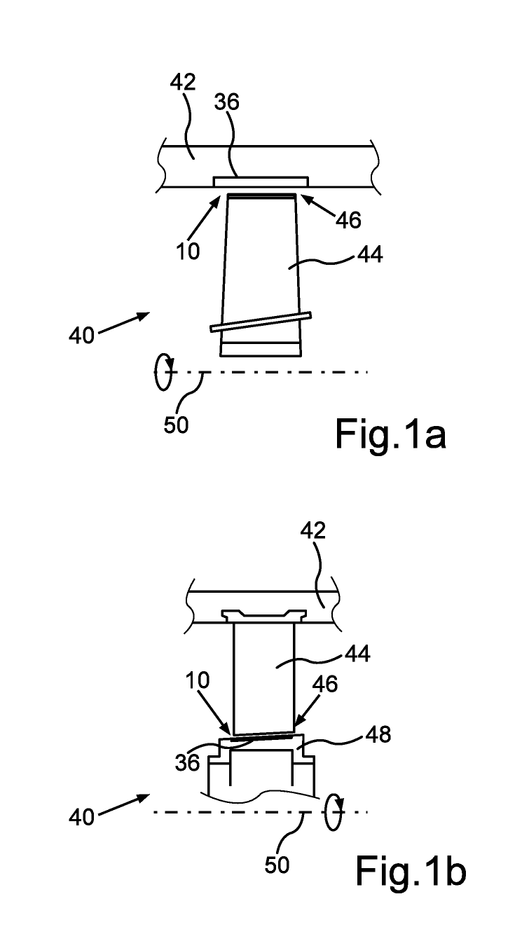

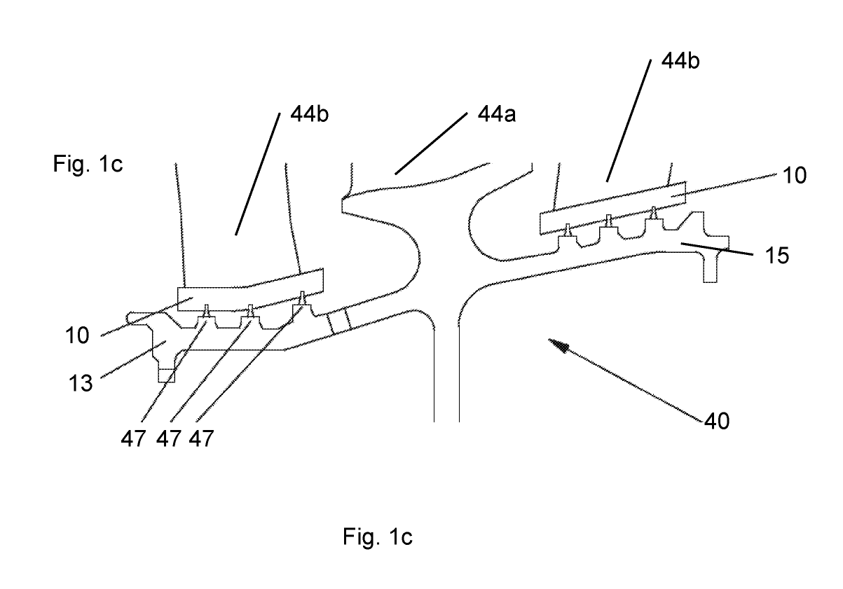

FIGS. 1a and 1b each show a cross-sectional view of a portion of a turbomachine 40, it being possible for turbomachine 40 to be configured as an engine, for example. In FIG. 1a, an abradable structure 10 is configured on a casing 42, whereas abradable structure 10 in FIG. 1b is configured on a rotor 48 of turbomachine 40. In the present case, abradable structure 10 is formed in one piece and has a carrier element 36 that is adapted for attaching abradable structure 10 to turbomachine 40, thus to casing 42 (FIG. 1a) or to rotor 48 (FIG. 1b).

Turbomachine 40 has a plurality of blade elements, of which a blade element 44 having a blade tip 46 is shown in FIGS. 1a and 1b. FIG. 1a shows blade element 44 as a rotor blade, whereas FIG. 1b shows blade element 44 as a guide vane. During operation of turbomachine 40, blade element 44, formed as a rotor blade in FIG. 1a, rotates about an axis of rotation 50, abradable structure 10 permitting a rubbing in and thus a rubbing contact of blade tip 46 against abradable structure 10 or against a structural surface of abradable structure 10 facing blade tip 46. In FIG. 1b, abradable structure 10 permits a rubbing contact in the form of blade tip 46 and the structural surface of abradable structure 10 facing blade tip 46 rubbing against one another. Thus, the rubbing contact may be in the form of a rubbing in, as shown in FIG. 1a, or in the form of a rubbing against, as shown in FIG. 1b, depending on whether abradable structure 10 is accommodated on casing 42 or on rotor 48. Thus, generally, abradable structure 10 may allow a rubbing contact in the form of the rubbing in as shown in FIG. 1a, as well as a rubbing contact in the form of the rubbing against as shown in FIG. 1b.

FIG. 1c shows another sectional view through a turbomachine 40. This view shows an inner band 13, 15 of the rotor, upon which sealing fins 47, formed as abrading elements, are configured upstream of a rotor blade 44a and downstream thereof. Together with an abradable coating 10 of preceding upstream and downstream configured stator 44b, they produce a sealing action. Sealing fins 47 thereby rub into abradable coating 10 when the rotor expands in response to centrifugal forces or high temperatures. It may also be provided that sealing fins 47 rub into abradable structure 10 upon a start-up of the turbomachine. This may advantageously reduce or prevent a leakage in the operating state of turbomachine 40.

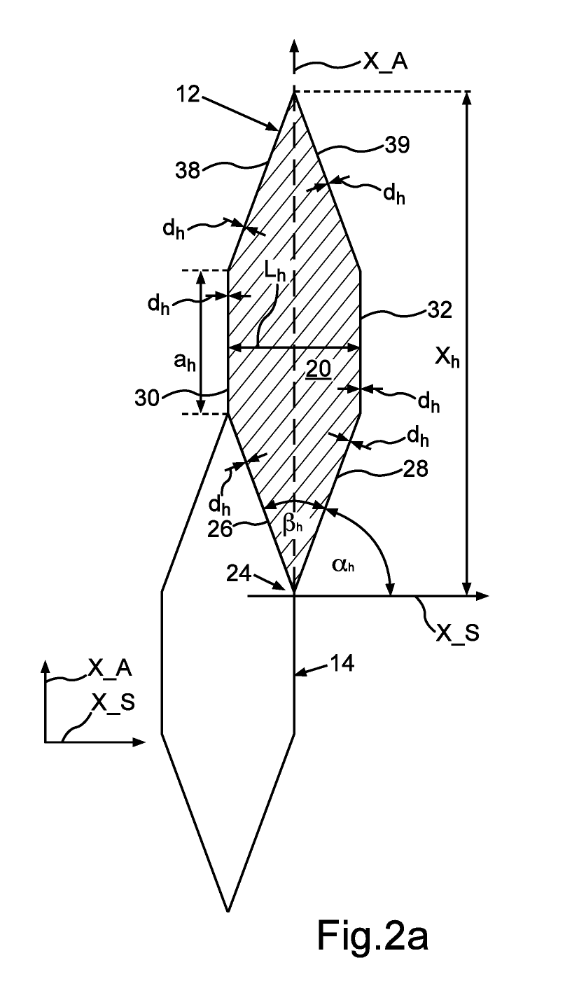

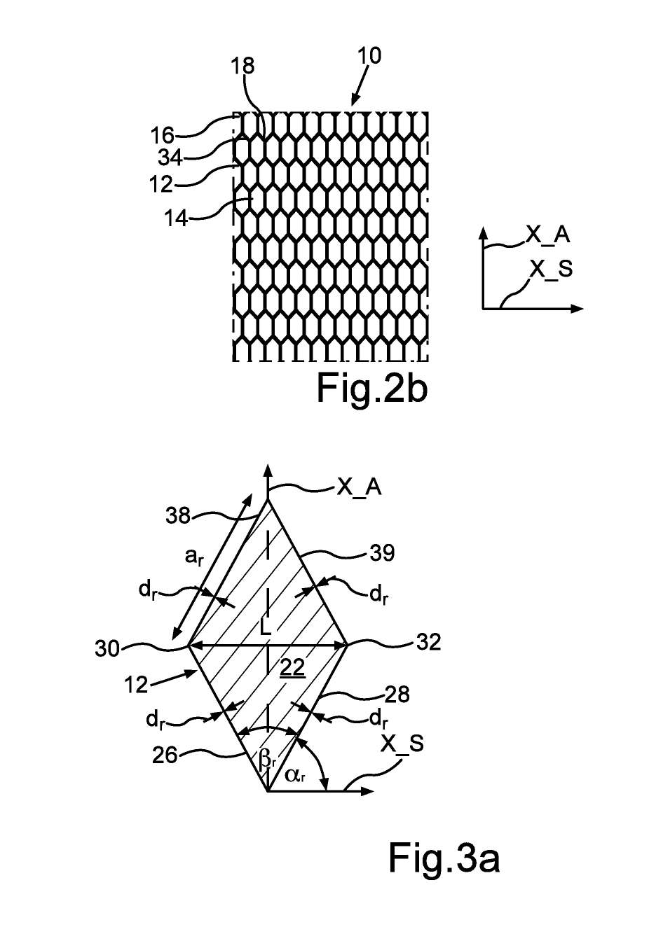

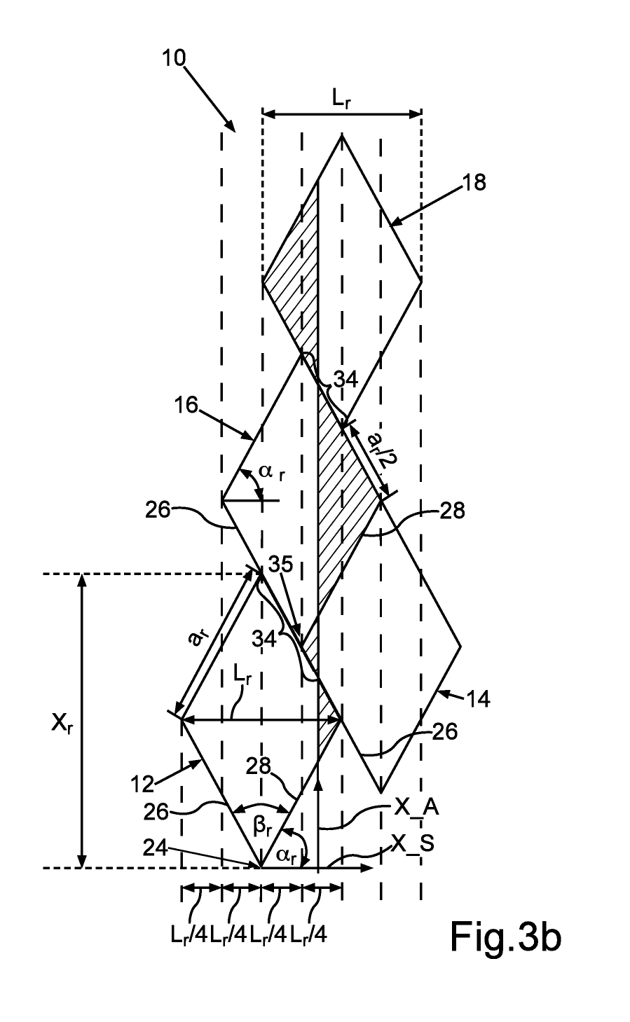

Abradable structure 10 is designed to be at least partially deformed by respective blade element 44 in response to a rubbing contact process carried out between blade element 44, respectively blade tip 46 and abradable structure 10 during operation of turbomachine 40 and, in addition or, alternatively, to be at least partially abraded. In this case, abradable structure 10 may be constituted of structural elements 12, 14, 16, 18 that may be adjacently disposed and, together, form the structural surface as an abradable liner. During operation of turbomachine 40, at least some of structural elements 12, 14, 16, 18 may become deformed and, additionally or alternatively, abraded, to keep a gap between blade tip 46 and abradable structure 10 as small as possible and, accordingly, be able to operate turbomachine 40 at a high level of efficiency. From the overall view of FIGS. 2a, 2b, 3a and 3b, it is discernible that structural elements 12, 14, 16, 18 may feature a respective polygonal cross section 20, 22 that is oriented in a rub direction X_A of abradable structure 10. The rubbing contact between abradable structure 10 and blade tip 46 may occur here in rub direction X_A; rub direction X_A being illustrated by an arrow in FIG. 2a through 3b. In the present case, polygonal cross section 20 is in the form of a hexagonal cross section, whereas polygonal cross section 22 is in the form of a diamond cross section. Thus, at least some of structural elements 12, 14, 16, 18 of abradable structure 10 may have a hexagonal cross section or a diamond cross section. Structural elements 12, 14, 16, 18 shown in FIG. 2a and, respectively, 2b feature the hexagonal cross section here, whereas structural elements 12, 14, 16, 18 shown in FIGS. 3a and 3b feature the diamond cross section. The hexagonal cross section is preferably in the form of a “hybrid” of honeycomb and diamond geometry, as is discernible, in particular, in FIG. 2a.

Polygonal cross sections 20, 22 preferably have an irregular form. In other words, polygonal cross sections 20, 22 have an irregular polygonal contour, as shown in the present case.

To obtain an especially favorable rub direction, as well as favorable sealing properties during operation of turbomachine 40, structural elements 12, 14, 16, 18 feature a greater extent Xₕ, Xᵣ in rub direction X_A than in a direction X_S of abradable structure 10 that is orthogonal to rub direction X_A. Orthogonal direction X_S is likewise shown in FIG. 2a through 3b by an arrow that is oriented orthogonally to rub direction X_A.

Within the scope of the present description, the subscript “h” denotes a dimension that refers to the hexagonal cross section (see FIGS. 2a and 2b), whereas subscript “r” denotes a dimension that refers to the diamond cross section (see FIGS. 3a and 3b). Accordingly, extent Xₕ denotes the extent of the structural elements, which have the hexagonal cross section, in rub direction X_A, whereas extent Xᵣ denotes the extent of structural elements 12, 14, 16, 18, which have the diamond cross section, in rub direction X_A.

At at least one respective structural element end 24 in rub direction X_A, structural elements 12, 14, 16, 18 feature structural element walls 26, 28 that converge in rub direction X_A and form a respective acute interior angle ßₕ, ßᵣ. Respective acute interior angle ßₕ, ßᵣ may thereby correspond to an angle of between 10° and 80°, preferably of between 30° and 60°, and especially of between 38° and 55°. Especially beneficial rubbing and sealing properties of abradable structure 10 are attainable at an angle of between 38° and 55°, in particular.

Structural elements 12, 14, 16, 18 may have at least two spaced apart element walls 30, 32 that are oriented along rub direction X_A. As shown in FIG. 2a, element wall 30, that is directly contiguous to structural element wall 26, may be joined thereto, whereas element wall 32, that is directly contiguous to structural element wall 28, may be joined thereto. In the case of structural element 12 having polygonal cross section 20 (hexagonal cross section), as shown in FIG. 2a, spaced apart element walls 30, 32 may have an extent in rub direction X_A having a side length aₕ. In the case of structural element 12 having polygonal cross section 22 (diamond cross section), as shown in FIG. 3a, element walls 30, 32 may be in the form of connecting pieces of the wall. On one side, element wall 30 is joined to structural element wall 26 and, on the other side, to a wall portion 38. On one side, element wall 32 is joined to structural element wall 28 and, on the other side, to a wall portion 39. Altogether, structural element walls 26, 28, as well as element walls 30, 32 and wall portions 38, 39 bound respective polygonal cross section 20, 22 of respective structural elements 12, 14, 16, 18.

FIGS. 2b and 3b show that mutually adjoining structural elements 12, 14, 16 are at least able to form a shared wall 34. Mutually adjoining structural elements 12, 14, 16 thereby overlap at shared wall 34, for example, in direction X_S that is orthogonal to rub direction X_A. This overlapping produces an offset in the array pattern of structural elements 12, 14, 16, 18 shown in FIG. 3b, so that, altogether, merely three structural element walls 26, 28 or element walls 30, 32 of structural elements 12, 14, 16 meet at nodal point 35. In comparison to related art structures, where four structural walls meet at one end of a honeycomb structure, for example, enhanced rubbing properties may be achieved by three structural element walls 26, 28 or element walls 30, 32 provided here coming together since less material of structural elements 12, 14, 16 is accumulated at nodal point 35 and, accordingly, a rubbing contact in rub direction X_A having a lower frictional resistance is made possible than in the case of related art structures.

In FIG. 2a, the respective dimensions of structural element 12 show a side length aₕ, a wall web thickness dₕ, an overhang angle αₕ, an extent Xₕ of the hexagonal cross section along rub direction X_A and a transverse extent Lₕ along orthogonal direction X_S. As the respective dimensions of structural element 12 having the diamond cross section, FIG. 3a shows a side length aᵣ, a wall web thickness dᵣ, an overhang angle αᵣ, an extent Xᵣ of the diamond cross section along rub direction X_A, as well as a transverse extent Lᵣ along orthogonal direction X_S. In the present case, transverse extent Lₕ, Lᵣ represents a cell width of respective structural elements 12, 14, 16, 18.

Respective overhang angle αₕ, αᵣ indicates an inclination of respective structural element wall 28 relative to orthogonal direction X_S. In the present case, the following angular relationships may apply for respective angles αₕ, αᵣ and ßₕ, ßᵣ:

2αₕ+ßₕ=180°

2αᵣ+ßᵣ=180°.

Especially favorable values for the rubbing and sealing properties are derived for structural elements 12, 14 having polygonal cross section 20 when the following dimension values are known:

αₕ=70°; ßₕ=40°; Lₕ/aₕ=0.868.

Accordingly, the rubbing and sealing properties are also favorable in the case of geometrically similar structural elements. Thus, transverse extent Lₕ may correspond, for example, to Lₕ=0.868 mm or—in the case of geometrically similar forms—to a multiple thereof. The same holds for side length aₕ that may correspond to a value of aₕ=1 mm.

Generally, the sealing action and rubbing properties may be enhanced in response to an increasing overhang angle αₕ, αᵣ (and thus a smaller interior angle ßₕ, ßᵣ). Generally, the sealing action is made possible by reducing side length aₕ, aᵣ since this yields particularly small leakage areas. The rubbing properties are enhanced by enlarging side length aₕ, aᵣ.

Especially effective rubbing and sealing properties are attainable for structural elements 12, 14, 16, 18 having the diamond cross section (polygonal cross section 22) when the following dimension values are provided:

αᵣ=63.5°; ßᵣ=53°; Lᵣ/aᵣ=0.894.

In summary, the present invention describes an abradable structure 10 having structural elements 12, 14, 16, 18, which, with respect to the geometry thereof (polygonal cross section 20, 22), are optimized to achieve especially favorable rubbing and sealing properties during operation of turbomachine 40 having abradable structure 10 or having a plurality of such abradable structures. In comparison to related art honeycomb structures, respective structural elements 12, 14, 16, 18 may have a greater wall thickness (wall web thickness dₕ, dᵣ) and, accordingly, are particularly suited for manufacturing in the scope of an additive manufacturing process, for example, by selective laser melting. The honeycomb web distances (transverse extent Lₕ, Lᵣ) which are narrow in comparison to related art honeycomb structures make it possible to achieve an especially favorable sealing action, thus especially favorable sealing properties. Elongating structural elements 12, 14, 16, 18 in rub direction X_A also makes it possible to manufacture wall web thicknesses dₕ, dᵣ having values of dₕ≥130 μm or dᵣ≥130 μm without the rubbing properties being degraded in comparison to the related art honeycomb structures. The production by an additive manufacturing process makes possible a single-piece manufacturing of entire abradable structure 10, thus, for example, a one-piece manufacturing of structural elements 12, 14, 16, 18 and of carrier element 36 which may be adapted to attach abradable structure 10 to turbomachine 40. Forming abradable structure 10 in one piece makes it possible to economize on production time and on the manufacturing costs of abradable structure 10. Inconel 718 may be used, for example, as material for abradable structure 10. This material may first be prepared in powder form and be bonded to abradable structure 10 by the additive manufacturing process.

### REFERENCE NUMERAL LIST

10 abradable structure
12 structural element
13 upstream inner band
14 structural element
15 downstream inner band
16 structural element
18 structural element
20 polygonal cross section
22 polygonal cross section
24 structural element end
26 structural element wall
28 structural element wall
30 element wall
32 element wall
34 shared wall
35 nodal point
36 carrier element
38 wall portion
39 wall portion
40 turbomachine
42 casing
44 abrading element; blade element
44a rotor blade or turbine blade
44b stator blade or guide vane
46 blade tip
47 sealing fin
48 rotor
50 axis of rotation
aₕ side length
aᵣ side length
dₕ wall web thickness
dᵣ wall web thickness
αₕ overhang angle
αᵣ overhang angle
ßₕ acute interior angle
ßᵣ acute interior angle

1-11. (canceled)

12. An abradable structure for a turbomachine, the abradable structure designed to be at least partially deformed or at least partially abraded by at least one abrading element of the turbomachine during operation thereof; the at least one abradable structure comprising:
at least regionally, structural elements having a respective polygonal cross section oriented in a rub direction of the abradable structure, wherein the structural elements have a greater extent in the rub direction than in a direction of the abradable structure orthogonal to the rub direction.

13. The abradable structure as recited in claim 12 wherein, at at least one respective structural element end in the rub direction, the structural elements have structural element walls converging in the rub direction and forming an acute interior angle.

14. The abradable structure as recited in claim 13 wherein the acute interior angle corresponds to an angle of between 10° and 80°.

15. The abradable structure as recited in claim 14 wherein the acute interior angle corresponds to an angle of between 30° and 60°

16. The abradable structure as recited in claim 15 wherein the acute interior angle corresponds to an angle of between 38° and 55°.

17. The abradable structure as recited in claim 12 wherein the structural elements have at least two spaced apart element walls oriented along the rub direction.

18. The abradable structure as recited in claim 12 wherein at least one structural element of the structural elements has a hexagonal cross section or a diamond cross section.

19. The abradable structure as recited in claim 12 wherein mutually adjoining structural elements of the structural elements at least form a shared wall.

20. The abradable structure as recited in claim 19 wherein the mutually adjoining structural elements overlap at the shared wall.

22. The abradable structure as recited in claim 12 further comprising at least one carrier element adapted for attaching the abradable structure to the turbomachine.

20. The abradable structure as recited in claim 12 wherein the abradable structure is formed in one piece.

21. A turbomachine comprising the abradable structure as recited in claim 12.

22. A method for manufacturing the abradable structure as recited in claim 12 wherein the abradable structure is produced by an additive manufacturing process.

23. A method for manufacturing the abradable structure as recited in claim 12 wherein the abradable structure is produced by selective laser melting.
